(19) United States
(12) Patent Application Publication
(10) Pub. No.: US 2006/0024221 A1
(43) Pub. Date: Feb. 2, 2006

(54) Device for producing a hot gas by oxidation using a simulated rotary reactor

(76) Inventors: Etienne Lebas, Vienne (FR); Stephane Bertholin, Villeurbanne (FR); Luc Nougier, Sainte Foy Les Lyon (FR); Beatrice Fischer, Lyon (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/194,523

(22) Filed: Aug. 2, 2005

(30) Foreign Application Priority Data
Aug. 2, 2004 (FR) 04/08.549

(51) Int. Cl. B01J 10/00

(52) U.S. Cl. 422/188

(57) ABSTRACT

The invention relates to a device for producing a hot gas by oxidation of an active material exhibiting an oxidized form and a reduced form by means of a simulated-rotation reactor.

### FIELD OF THE INVENTION

The present invention relates to the sphere of energy production, of gas turbines, boilers and ovens, notably for the petroleum industry, the glass industry and cement works. The invention also relates to the use of these various means for production of electricity, heat or steam.

The field of the invention concerns, more particularly, the devices and methods allowing, through reactions of oxyreduction of an active phase, to produce a hot gas by means of a hydrocarbon or of a mixture of hydrocarbons and to isolate the carbon dioxide so as to be able to capture it. The invention also applies to the sphere of hydrogen or oxygen production.

The growth in the worldwide energy demand leads to build new thermal power plants and to emit increasing amounts of carbon dioxide harmful to the environment. Capture of carbon dioxide with a view to its sequestration has thus become an imperative necessity.

### BACKGROUND OF THE INVENTION

One of the techniques that can be used to capture carbon dioxide consists in using oxyreduction reactions of an active phase to decompose the combustion reaction commonly used into two successive reactions:
an oxidation reaction of the active phase with air allows, through the exothermic character of the oxidation, to obtain a hot gas whose energy can be used,
a reduction reaction of the active phase thus oxidized by means of a reducing gas then allows to obtain a re-usable active phase and a gaseous mixture essentially comprising carbon dioxide and water.

The uncoupling thus achieved between the oxidation stage and the reduction stage later allows easier separation of the carbon dioxide from a gaseous mixture practically free of oxygen and nitrogen.

The state of the art includes systems allowing recovery of the CO₂, but not according to the present invention which consists in using a simulated rotary reactor allowing to manage 3 successive and distinct stages; an oxidation stage, a sweep stage and a reduction stage, these 3 stages following one another in the course of time according to a well-determined sequence.

American patent U.S. Pat. No. 5,447,024 describes a method comprising a first reactor using a reaction of reduction of a metal oxide by means of a reducing gas, and a second reactor producing said metal oxide by oxidation reaction with dampened air. The exhaust gases from the two reactors are fed into the gas turbines of an electric power plant. The method described in this patent allows, by means of the oxyreduction reactions on a metal, to isolate the carbon dioxide in relation to nitrogen, which thus facilitates capture of the carbon dioxide.

However, implementing such a method requires two distinct reactors and means for transporting an active phase that comes in form of solid particles. Such a method is therefore relatively complicated to implement and involves considerable operating and maintenance costs. Besides, entrainment of fine particles of the active phase in the exhaust gases can be a source of drawbacks in relation to later processing of these gases.

One object of the invention is therefore to allow to easily isolate the carbon dioxide produced by thermal generators of various types, notably gas turbines, ovens and boilers, in order to facilitate its capture, while overcoming the aforementioned problems.

Another object of the invention is to improve the device described in patent application FR-2,846,710 which related to a real rotary reactor in the sense that the reactor object of the invention exhibited a material rotation between a stationary part and a moving part. This type of reactor requires a sealing piece between the stationary part and the moving part that is quite difficult to achieve, at least from a certain reactor size.

### SUMMARY OF THE INVENTION

The type of reactor described in the present application allows to carry out the same reactions as the reactor described in patent application FR-2,846,710, but without requiring a real rotation. Rotation, or more precisely changing from one reactor configuration to another, is obtained in the present application by the time lag applied, at fixed periodicities, to a set of modules, preferably identical, each one capable of being supplied by specific means with an oxidizing gas, a reducing gas or an inert gas (also referred to as sweep gas).

In the description hereafter, what is referred to as stage is any one of the oxidation, reduction or sweep stages, and the material means allowing said stage to be carried out.

These material means essentially comprise the system of valves allowing to deliver on each module, according to the period of time considered, the oxidizing gas, the sweep gas or the reducing gas. These means are specific to each module.

The invention thus relates to a device for producing a hot gas by oxidation of an active material, the device comprising a plurality of reaction modules, and each one can be, in the course of time, in the oxidation, reduction or sweep stage. The modules, preferably identical, are grouped together in zones corresponding to the oxidation, reduction or sweep zones.

Each zone is defined by the number of modules it contains, i.e. the number of successive modules working all in one of the well-determined oxidation, reduction or sweep stages.

All the modules of a single zone work under the same operating conditions. Because of the periodic time lag of the stage in which the modules work, although the modules are materially fixed, the zones move in the course of time at the speed of one module per lag period, and they eventually get back to their initial position after a certain time that is a multiple of the lag period, which will be referred to as cycle time hereafter.

It is in this sense that the term simulated rotation is used.

The device according to the invention can therefore be defined as a device for producing a hot gas by oxidation of an active material, comprising a set of reaction modules, each module comprising an active material working, as a function of time, successively in an oxidation, sweep and reduction stage by being contacted respectively with an oxidation, sweep or reducing gas, characterized in that said contacting is carried out by means of a supply system specific to each module and capable of receiving, as a function of time, an oxidation, a sweep or a reducing gas, in that all of the successive modules working in the oxidation stage form the oxidation zone and produce said hot gas, all of the modules working in the reduction stage form the reduction zone and produce a reduction effluent, all of the modules working in the sweep stage form the sweep zone and produce an effluent mainly consisting of the sweep gas, and in that each zone comprises a predetermined number of modules moving at each time period (T) by an increment equal to one module, so that each module works in the course of time according to an oxidation, sweep, reduction, sweep, oxidation sequence; said sweep stage always follows the oxidation stage or the reduction stage.

In the text hereafter, no distinction is made between the case where the reactor comprises a single oxidation, reduction or sweep zone, and the case where it comprises several such zones, because the latter case brings no change in the reactor operation.

In general terms, the number of modules working in an oxidation zone in relation to the number of modules working in a sweep zone ranges between 1 and 12, preferably between 1 and 10.

The invention also relates to a method for implementing the device described above.

The active material used in the device which is the object of the invention generally comprises at least one metal that may come either in oxidized or in reduced form.

What is referred to as oxidized form is any form of the metal that has undergone an oxidation reaction. Similarly, what is referred to as reduced form is any form of the metal that has undergone a reduction reaction, i.e. at a lower oxidation level than the level corresponding to the oxidized form.

For example, the CeO₂ molecule corresponds to a reduced form in relation to the CeO₃ molecule.

The metal or metals of the active material can be selected from the group consisting of copper, nickel, cerium, cobalt, iron, or it can be any combination of these metals.

Preferably, the metal or metals of the active material are selected from the group consisting of nickel and cerium.

According to the invention, the reaction modules have an exchange surface that is coated, at least partly, with the active material.

The oxidizing gas is a gas comprising an oxidizing compound, generally oxygen.

The oxidizing gas can comprise 5 to 100% by weight, preferably 7 to 70% by weight, more preferably 10 to 30% by weight of oxygen.

The oxidizing gas used in the device of the invention is preferably air or dampened air. Thus, under the action of the oxidizing gas, at least part of the active material progressively changes from a reduced form to an oxidized form. Oxidation being an exothermic reaction, the effluent produced by the oxidation reaction is hot. The gas produced at the end of the oxidation stage is therefore referred to as hot gas.

The reducing gas generally consists of a mixture of hydrocarbons and of steam. It can be, in some cases, natural gas. The reducing gas can comprise at least 30%, preferably at least 50% by weight of methane.

It can in some cases consist of a mixture of carbon monoxide, carbon dioxide and hydrogen well-known to the man skilled in the art as synthesis gas.

It can, in the most general case, consist of any mixture of hydrocarbons, steam, carbon monoxide, carbon dioxide and hydrogen.

Thus, under the action of the reducing gas, at least part of the active material progressively changes from an oxidized form to a reduced form.

Preferably, the inert gas consists of a mixture of carbon dioxide and of steam.

Under the action of the inert (or sweep) gas, the reaction modules are swept prior to working in oxidation or reduction mode so as to prevent any risk of explosion that might result from contacting the oxidizing gas and the reducing gas.

### BRIEF DESCRIPTION OF THE FIGURES

Other features and advantages of the invention will be clear from reading the description hereafter, with reference to the accompanying figures wherein:

FIG. 1 is a flowsheet of the simulated-rotation reactor in a non-limitative vertical configuration,

FIG. 2 relates to a module and shows an example of valves associated with each module, allowing to deliver in the course of time, at the inlet, 3 distinct fluids corresponding to the 3 ways A, B, C and, at the outlet, the 3 effluents corresponding to the three ways D, E, F.

### DETAILED DESCRIPTION

The device according to the invention, referred to as simulated rotary reactor (SRR), consists of a set of identical modules, and each module can work, as a function of time, in an oxidation, reduction or sweeping stage.

The modules are materially grouped together in different ways depending on applications. In applications involving reactions occurring under pressure, it can be of interest to group the modules together in compact form within a preferably cylindrical enclosure.

According to another layout, each module withstands the pressure imposed by the application, that can in some cases reach several ten bars, which then allows the modules to be simply arranged on a skid.

In other applications, the modules can be aligned along a common axis with any angle in relation to the vertical according to space requirements. It is important to underline that the invention is in no case bound by a particular layout of the modules.

The invention is based on the fact that each module, whatever the configuration involved, works as a function of time in an oxidation, sweep, reduction, sweep, stage, the stages following one another in this order which defines the working sequence of the reactor.

The time period during which any module works in one of the predetermined oxidation, sweep or reduction stages allows the sequence to be completely defined. This time period is equal to the lag period multiplied by the number of modules corresponding to a determined zone. The reactor working sequence is thus perfectly defined by the succession of zones (oxidation, sweep and reduction) and the number of modules that each zone contains.

Each module has an inlet end through which the incoming gas is fed, and an outlet end through which the outgoing gas or effluent is fed. The inlet end is equipped with a system of valves allowing, according to the time period considered, to receive the oxidizing gas, the sweep gas or the reducing gas.

The outlet end is similarly equipped with a valve system allowing to receive, according to the time period considered, the oxidation stage effluent, i.e. the hot gas, the sweep gas possibly containing some traces of the effluent from the previous oxidation or reduction stage, and the reduction stage effluent.

The modules do not communicate with one another and they work in parallel.

They are simply juxtaposed according to the configuration selected. Of course, mechanical fastening elements known to the man skilled in the art allow them to be maintained in their relative position.

These fastening elements can be very diverse and are in no way limitative of the present invention.

Each module comprises an active material that is selected from a set of metallic materials that can have two forms, an oxidized form and a reduced form.

The oxidized form of the active material is obtained by means of an oxidizing gas and the reduced form of the active material is obtained by means of a reducing gas.

A third gas, generally steam, is used for the sweep stage.

By way of example, in the case of a nickel-based active material, an oxygen-based oxidizing gas and a methane-based reducing gas, the oxyreduction reactions can be illustrated by the following formulas:
2 Ni+O2->2 NiO,
4 NiO+CH₄->CO₂+2 H₂O+4 Ni
wherein Ni is nickel in its reduced form and NiO is nickel in its oxidized form.

In the case of a cerium-based active material, an oxygen-based oxidizing gas and a methane-based reducing gas, the oxyreduction reactions can be illustrated by the following formulas:
2 Ce₂O₃+O2->4 CeO₂,
8 CeO₂+4 CH₄->4 CO₂+2 H₂O+4 Ce₂O₃
wherein CeO₂ is cerium in its reduced form and Ce₂O₃ is cerium in its oxidized form.

In an embodiment of the invention, each module can consist of a set of monoliths aligned along the same axis, such as those used in catalytic converters.

Each monolith defines a plurality of parallel channels of typical dimension of the order of one millimeter. This system of parallel channels can be provided on its inner wall with a coating that constitutes, after impregnation, the aforementioned active material.

Coating techniques are well-known to the man skilled in the art and the present invention is bound by no particular coating technique.

The oxidizing, reducing or sweep gas, according to the stage considered, circulates within said channels which afford, after the coating operation, a significant exchange surface area.

Typically, in a standard monolith of the type of those used for manufacturing catalytic converters, the exchange surface area can be of the order of one hundred m² per meter in length of channels.

In another embodiment of the invention, each module can consist of a set of balls or extrudates contained in a porous basket allowing passage of the gas inside said module.

In another embodiment of the invention, the active material can be deposited on a substrate in form of a foam or of a sponge comprising pores that form passages through which the gas circulates.

According to a preferred embodiment of the invention, each module comprises a set of monoliths aligned along the same axis, defining a network of parallel channels and of side dimension ranging between 1 and 5 mm.

The monolith generally comprises a coating on the inner walls of the channels, a coating on which the active material is deposited.

It is also possible to use a monolith massively consisting of the active material itself.

The monolith can consist of a metal alloy or of ceramic.

The materials used for the monolith can be, for example, dense alumina, mullite, silicon carbide, cordierite or an alloy based on iron, chromium and aluminium, such as Fecralloy (FeCrAl).

The coating can comprise one or more refractory oxides whose surface area and porosity are greater than those of the monolith. Preferably, the coating is based on alumina or zirconia, possibly doped with rare earths or silica.

The monolith preferably comprises cordierite on which the active material is deposited by means of a coating based on alumina or zirconia.

The active material endows the monolith with a chemical function, for carrying out the oxyreduction reactions sought within the scope of the invention, and the channel structure developing a considerable specific surface allows a physical thermal transfer function.

It is in fact important for the generally endothermic reduction stage to take place on a set of monoliths that have kept the thermal level they had reached at the end of the exothermic oxidation stage. In fact, this thermal level at the start of the reduction stage is generally lower than the level reached at the end of the oxidation stage because of the intermediate sweep stage which will consume part of the monolith heat. This explains why this sweep stage has to be, if possible, reduced to the minimum required.

In order to maximize the conversion rate of the desired reactions, it is furthermore necessary for the exchange surface area between the gas and the active material to have a maximum value.

It is thus advantageous to select a monolith having the highest possible channel density.

The channel density of the monolith often ranges between 100 and 900, preferably between 200 and 600 CPSI (cell per square inch).

In general, the ratio of the surface area to the volume of the monolith increases when the density of the channels is increased.

The channels generally have an equivalent diameter ranging between 0.1 and 10 mm, preferably between 0.5 and 2 mm, for example 1 mm. The term equivalent diameter has to be taken in the sense of hydraulic diameter, well-known to the man skilled in fluid mechanics.

The supply and discharge means of each module respectively allow to supply and to discharge the gas concerned according to the time period considered, at each end of said modules. In order to provide each of the 3 operating stages (oxidation, sweep and reduction), each module has to be equipped with a means intended for supply and discharge of each one of the three corresponding gases, i.e. the oxidizing gas, the sweep gas and the reducing gas.

The supply means can comprise a diffuser. Similarly, the discharge means can comprise a collector. The function of the diffusers and of the collectors is to allow good distribution of the gas supplied or discharged over the entire section of a module. This point is important in order to supply the plurality of channels forming a module in the most uniform way possible, in the preferred variant involving monoliths.

The invention also relates to an energy generation method using the device according to the present invention, comprising:
continuously feeding, through specific supply means, an oxidizing gas, possibly compressed, a reducing gas and an inert gas into the corresponding zones of the simulated-rotation reactor, i.e. the oxidation, reduction and sweep zones,
recovering a hot gas as the effluent of the oxidation zone, a gas essentially comprising carbon dioxide and water as the effluent of the reduction zone, and a sweep gas as the effluent of the sweep zone, this recovery being carried out through specific discharge means, and
separating the carbon dioxide from the water contained in the reduction zone effluent, in an auxiliary unit that is not part of the present invention.

The calories of the gas essentially comprising carbon dioxide and water are preferably exchanged in an exchanger exterior to the device according to the invention to provide steam.

One essential advantage of the present invention is to allow easy recovery of a gas essentially containing CO₂ and water, so as to carry out later separation of the CO₂ with a view to its sequestration.

Another advantage of the invention is to provide a simple, reliable and inexpensive means for implementing oxyreduction reactions.

Such a simplification is mainly due to the removal of rotating parts (notably in relation to the device described in patent application FR-2,846,710) and to the fact that each module of the reactor can work in the course of time in oxidation, sweeping and reduction stage.

Another advantage of the invention is to overcome problems linked with the transport of an active phase in form of particles. Transport of these particles involves specific and expensive equipments. Preventing the presence of fine particles in the exhaust gases allows to notably decrease the maintenance costs.

Finally, another advantage of the invention is to allow to carry out oxyreduction reactions in a device operating with limited pressure drops, since all the implementation variants of the active material, notably in form of a monolith, are characterized by a very high porosity.

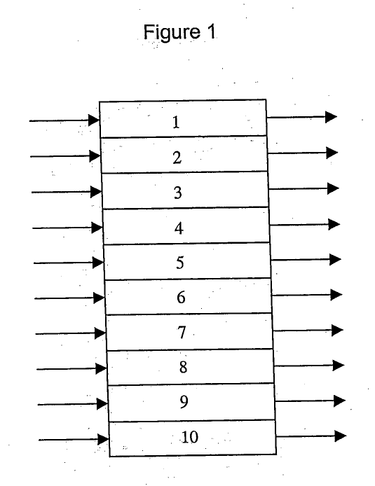

FIG. 1 allows to better understand operation of the reactor according to the invention without limiting the latter since the modules can have any number and any orientation.

The reactor of FIG. 1 comprises 10 modules, vertically layered to facilitate description, numbered from 1 to 10 from top to bottom.

The modules do not communicate with one another and each one receives the incoming fluid at one end and releases the outgoing effluent through the opposite end to the inlet end.

For the clarity of our explanation, we assume that, in the initial configuration t0, the oxidation zone (denoted by o) corresponds to modules 1, 2, 3, 9, 10, the sweep zone (denoted by i) corresponds to module 4 and to module 8, and the reduction zone (denoted by r) corresponds to modules 5, 6, 7. We denote this original position by oooirrrioo, by designating by o the modules in the oxidation stage, i the modules in the sweep stage and by r the modules in the reduction stage.

After a lag period T, i.e. at t0+T, the modules are shifted by one unit downwards.

We thus obtain for modules 1 to 10 the configuration denoted by ooooirrrio. At t0+2T, we obtain the configuration oooooirrri and so on.

The notion of lag and the fact that, after a time t=10T, we come back to the initial position are thus better understood.

Each module thus works in the course of time in an oxidation, sweep or reduction stage, and changing from one stage to another is possible by means of a system of valves delivering, for each module, the gas corresponding to its function at a given time t.

The system of valves is not the object of the invention, and it is for example similar to the system used in the ELUXYL type simulated countercurrent reactors described for example in patent FR-2,762,793.

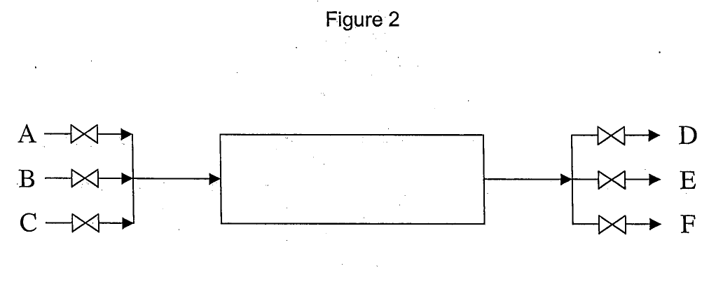

The important point to be achieved by this system of valves is to be able to deliver to each module of the reactor the oxidation, sweep or reducing gas according to the period concerned, as diagrammatically shown in FIG. 2.

Similarly, at the module outlet, a system of valves allows to recover the hot gas, the sweep gas or the effluent gas from the reduction stage.

The device for producing a hot gas according to the invention can, according to the reactions involved, provide a distribution between the oxidation zone, the reduction zone and the sweep zone that is highly variable as the case may be, but generally the number of modules working in oxidation zone in relation to the number of modules working in sweep zone ranges between 1 and 12, preferably between 1 and 10.

The lag period of the module of the reactor according to the invention can also be within a rather wide range depending on the reactions involved, but it generally ranges between 10 seconds and 500 seconds, preferably between 10 seconds and 100 seconds.

The circulation rate of the gas within each module working in oxidation, reduction or sweep stage generally ranges between 0.1 and 50 m/s, preferably between 0.5 and 10 m/s. This rate is of course limited by the pressure drop which may become prohibitive.

### EXAMPLE

The present invention will be clear from reading the non limitative example described hereafter.

The example described in connection with FIG. 1 allows to produce a CO₂-free hot gas and fumes essentially containing CO₂ from natural gas.

The natural gas used has the following composition, given in molar fractions:

| | |
|---|---|
| Methane | 0.82 |
| Ethane | 0.094 |
| Propane | 0.047 |
| i-Butane | 0.008 |
| n-Butane | 0.008 |
| i-Pentane | 0.007 |
| Nitrogen | 0.009 |
| Carbon dioxide | 0.007 |

The reactor used, diagrammatically shown in FIG. 1, consists of 10 identical modules 1.3 m in diameter and 3.8 m in length, arranged in form of 2 horizontal rows, each one comprising 5 modules.

Each module contains 2293 kg nickel deposited on the walls of the monoliths of each module and can be individually supplied with air, steam or natural gas as diagrammatically shown in FIG. 2.

The modules are numbered from 1 to 10 from top to bottom in FIG. 1, but the representation of. FIG. 1 is diagrammatic and, in the reactor according to the example, there are 2 parallel rows of 5 modules.

All the time, 7 consecutive modules work in the oxidation stage (air supply), 1 module works in the reduction stage (natural gas supply) and 2 modules work in the sweep stage, each sweep module being inserted between the group of modules working in oxidation mode and the module working in reduction mode.

The reactor is thus supplied, for the modules working in oxidation mode, with air at 20 bars and 500° C. with a flow rate of 278 kg/s. This flow is divided into 7 identical streams, each one of the 7 streams feeding 7 consecutive modules of the reactor.

The reactor is supplied for the modules working in sweep mode with steam at 20 bars and 500° C. at a flow rate of 17 kg/s.

This flow is divided into 2 identical streams, each one of the 2 streams feeding each one of the 2 modules working in sweep mode.

Finally, the reactor is supplied with natural gas at 20 bars and 40° C. with a flow rate of 4 kg/s, this flow feeding the whole of the reactor module working in reduction mode.

The lag period is 30 seconds and the cycle time is 300 seconds.
At the time t=0, module 1 is supplied with natural gas, module 2 is supplied with steam, modules 3 to 9 are supplied with air and module 10 is supplied with steam. This corresponds to configuration rioooooooi,
At the time t=30s, feeding is permutated: module 1 is supplied with steam, module 2 is supplied with natural gas, module 3 is supplied with steam and modules 4 to 10 are supplied with air. This corresponds to configuration iriooooooo,
At the time t=60s, feeding is permutated again: module 1 is supplied with air, module 2 is supplied with steam, module 3 is supplied with natural gas, module 4 is supplied with steam and modules 5 to 10 are supplied with air. This corresponds to configuration oirioooooo.

These permutations are thus continued according to a 30-second period.

The complete cycle, i.e. the period of time necessary for the reactor to be back in its initial position, is 300 seconds.

The air-supplied modules perform oxidation of the nickel to nickel oxide and produce hot air at 1050° C.

The two steam-supplied modules are in the sweep stage.

The natural gas-supplied module performs reduction of the nickel oxide to nickel and essentially produces carbon dioxide and water, the water can be condensed so as to have a flow essentially containing carbon dioxide.

The reactor thus produces 262 kg/s hot gas at about 1050° C. essentially containing nitrogen and oxygen, and about 2 kg/s fumes essentially containing carbon dioxide and water.

1) A device for producing a hot gas by oxidation of an active material, comprising a set of reaction modules, each module comprising an active material and working, as a function of time, successively in an oxidation, sweep and reduction stage by being contacted respectively with an oxidation, sweep or reducing gas, characterized in that said contacting is carried out by means of a supply system specific to each module and capable of receiving, as a function of time, an oxidation, a sweep or a reducing gas, in that all of the successive modules working in the oxidation stage form the oxidation zone and produce said hot gas, all of the modules working in the reduction stage form the reduction zone and produce a reduction effluent, all of the modules working in the sweep stage form the sweep zone and produce an effluent mainly consisting of the sweep gas, and in that each zone comprises a predetermined number of modules moving at each time period (T) by an increment equal to one module, so that each module works in the course of time according to an oxidation, sweep, reduction, sweep, oxidation sequence.

2) A device for producing a hot gas as claimed in claim 1, wherein the oxidizing gas contains 5% to 100% by weight, preferably 7% to 70% by weight, more preferably 10% to 30% by weight of oxygen.

3) A device for producing a hot gas as claimed in claim 1, wherein the reducing gas essentially contains methane and steam.

4) A device for producing a hot gas as claimed in claim 1, wherein the sweep gas essentially contains carbon dioxide or steam.

5) A device for producing a hot gas as claimed in claim 1, wherein the active material consists of a metal having at least an oxidized form and a reduced form, selected from the group consisting of copper (Cu), nickel (Ni), cerium (Ce), cobalt (Co) and iron (Fe), or any combination of these metals.

6) A device for producing a hot gas as claimed in claim 1, wherein each module is equipped with a set of identical monoliths defining a plurality of parallel channels, whose inner walls are impregnated with the active material.

7) A device for producing a hot gas as claimed in claim 1, wherein each module is equipped with a set of balls or extrudates confined in a porous basket, the balls or extrudates consisting at least partly of the active material.

8) A device for producing a hot gas as claimed in claim 1, wherein the number of modules working in the oxidation stage in relation to the number of modules working in the sweep stage ranges between 1 and 12, preferably between 1 and 10.

9) A device for producing a hot gas as claimed claim 1, wherein the lag period of the reactor modules ranges between 10 seconds and 500 seconds, preferably between 10 seconds and 100 seconds.

10) A device for producing a hot gas as claimed claim 1, wherein the rate of circulation of the gas within each module working in oxidation, reduction or sweep stage ranges between 0.1 and 50 m/s, preferably between 0.5 and 10 m/s.

11) A device for producing a hot gas as claimed in claim 1, wherein the monolith constituting each module consists of a metal alloy or of ceramic, the materials used being selected from the group made up of dense alumina, mullite, silicon carbide, cordierite or an alloy based on iron, chromium and aluminium, such as Fecralloy (FeCrAl).

12) An energy generation method using the device as claimed in claim 1, comprising:
feeding an oxidizing gas, possibly compressed, a reducing gas and an inert gas into the corresponding zones of the reactor, i.e. the oxidation, reduction and sweep zones,
recovering a hot gas as the effluent of the oxidation zone, a gas essentially comprising carbon dioxide and water as the effluent of the reduction zone, and a sweep gas as the effluent of the sweep zone, and
separating the carbon dioxide from the water contained in the reduction zone effluent, in an auxiliary unit.
